(19) United States
(12) Patent Application Publication
(10) Pub. No.: US 2026/0119830 A1
(43) Pub. Date: Apr. 30, 2026

(54) Systems and Methods for Batch Barcode Scanning

(71) Applicant: Zebra Technologies Corporation, Lincolnshire, IL (US)

(72) Inventors: Dongqing Chen, East Setauket, NY (US); Kui Liu, Irvine, CA (US); David S. Koch, East Islip, NY (US)

(73) Assignee: Zebra Technologies Corporation, Lincolnshire, IL (US)

(21) Appl. No.: 18/932,111

(22) Filed: Oct. 30, 2024

(51) Int. Cl. G06K 7/14

(52) U.S. Cl. CPC G06K 7/1443; G06K 7/1413; G06K 7/1465

(57) ABSTRACT

A method includes: capturing a first image; detecting a plurality of barcodes in the first image; initiating a decode operation for each of the barcodes; controlling a display to present: in a first region of the display, a field of view of an image sensor, and in a second region of the display, a reference pane including (i) the first image, and (ii) a decode status indicator associated with a first barcode of the plurality of barcodes, the decode status indicator corresponding to an outcome of the decode operation for the first barcode; and updating the reference pane based on at least one further decode operation.

### BACKGROUND

An image-based barcode scanner may capture an image depicting multiple barcodes, and attempt to decode each barcode in the image. Under some conditions, however, e.g., dependent on ambient light levels and/or the distance between the scanner and the barcodes, the scanner may fail to decode certain barcodes in the image.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a computing device for image-based batch barcode scanning.

FIG. 2 is a diagram illustrating an image of barcodes for batch barcode scanning.

FIG. 3 is a flowchart of a method of batch barcode scanning.

FIG. 4 is a diagram illustrating an example performance of blocks 305 and 310 of the method of FIG. 3.

FIG. 5 is a diagram illustrating an example performance of blocks 320 and 325 of the method of FIG. 3.

FIG. 6 is a diagram illustrating an example performance of blocks 330 and 335 of the method of FIG. 3.

FIG. 7 is a diagram illustrating an example performance of block 340 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to a method, comprising: capturing a sequence of images including a first image and a plurality of further images; detecting a plurality of barcodes in the first image; for each of the plurality of further images: detecting at least one of the plurality of barcodes; initiating a decode operation for the at least one barcode; determining a position of the at least one barcode within the first image; and controlling a display to indicate a result of the decode operation at the position.

Further examples disclosed herein are directed to a method including: capturing a first image; detecting a plurality of barcodes in the first image; initiating a decode operation for each of the barcodes; controlling a display to present: in a first region of the display, a field of view of an image sensor, and in a second region of the display, a reference pane including (i) the first image, and (ii) a decode status indicator associated with a first barcode of the plurality of barcodes, the decode status indicator corresponding to an outcome of the decode operation for the first barcode; and updating the reference pane based on at least one further decode operation.

Additional examples disclosed herein are directed to a computing device, comprising: an image sensor; a display; and a processor configured to: capture a first image; detect a plurality of barcodes in the first image; initiate a decode operation for each of the barcodes; control the display to present: in a first region of the display, a field of view of an image sensor, and in a second region of the display, a reference pane including (i) positions of each of the barcodes in the first image, and (ii) a decode status indicator associated with a first barcode of the plurality of barcodes, the decode status indicator corresponding to an outcome of the decode operation for the first barcode; and update the reference pane based on at least one further decode operation.

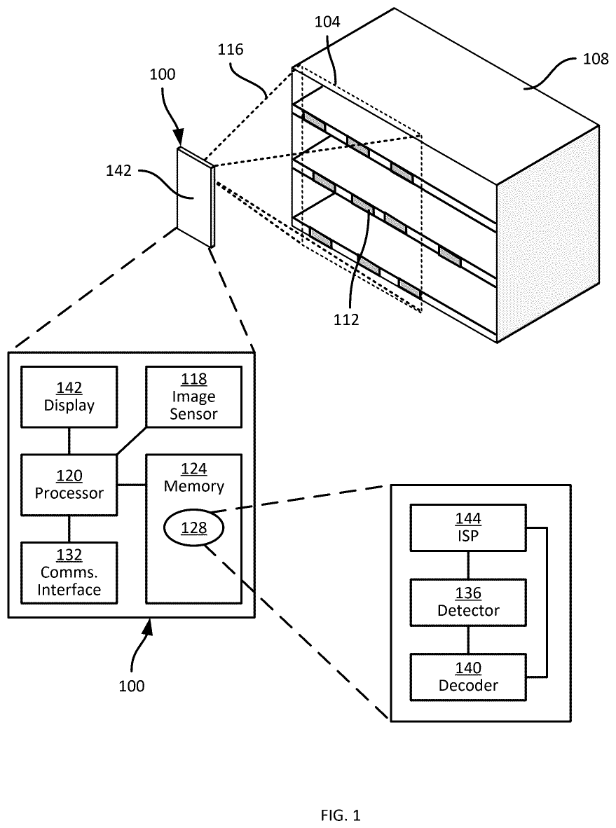

FIG. 1 illustrates a computing device 100, such as a mobile computer, a smart phone, a barcode scanner, an imaging device mounted on a chassis of an autonomous or semi-autonomous apparatus, or the like. The device 100 includes a housing supporting various components of the device 100, discussed below. The device 100 can be operated to capture images, and is configured to detect barcodes within such images and to decode the detected barcodes. In the discussion below, the term “barcode” includes symbols using one-dimensional symbologies that encode data in linear arrays (e.g., UPC-A, Code 128, and the like), as well as symbols with two-dimensional symbologies (e.g., Data Matrix, QR Code, DotCode, and the like). In further embodiments, the mechanisms described below can be implemented to detect and decode other forms of machine-readable information, such text (e.g., to implement an optical character recognition process or the like).

For example, the device 100 can be operated to capture an image representing a region 104 of a shelf or other support structure 108 that supports one or more barcodes 112 (illustrated as grey boxes in FIG. 1). In the illustrated example, the support structure 108 includes shelves, and the barcodes 112 are disposed on shelf edges, e.g., facing into an aisle of a facility in which the device 100 is deployed. A wide variety of other objects, or collections of objects, can carry the barcodes 112 in other examples. For example, the barcodes 112 can be affixed to packages in a sorting facility, on products on the support structure 108, or the like. In other examples the barcodes 112 can be presented on a sheet, e.g., listing a set of items in a pallet or other aggregation of inventory. Such a sheet may therefore include a grid or list containing multiple barcodes.

The region 104 of the support structure 108 contains nine barcodes 112 in the illustrated example, although it will be understood that other images captured by the device 100 may encompass larger or smaller numbers of barcodes 112. The barcodes 112 appear at various positions within the region 104 of the support structure 108. The extent of the region 104 is determined by a field of view (FOV) 116 of an image sensor 118 of the device 100 (e.g., a camera). In some examples, the device 100 can include more than one image sensor. For example, the device 100 can include a first image sensor, e.g., configured to capture images with a first resolution (e.g., 15 megapixels (MP)), and a second image sensor, e.g., configured to capture images with a second resolution (e.g., 2 MP). The FOVs of the image sensors overlap, but need not be identical. The device 100 can store calibration data defining a transformation between the FOV of the first image sensor and the FOV of the second image sensor. It will be understood that in the discussion below, the capture of images via the image sensor 118 can include capturing images using one or the other of the image sensors mentioned above, or both of the image sensors simultaneously.

The image sensor 118 can be supported by a housing of the device 100, along with various other components of the device 100, including a processor 120, such as a central processing unit (CPU), graphics processing unit (GPU), application-specific integrated circuit (ASIC), or the like. The processor 120 is communicatively coupled with a non-transitory computer-readable storage medium such as a memory 124, e.g., a combination of volatile memory elements (e.g., random access memory (RAM)) and non-volatile memory elements (e.g., flash memory or the like). The memory 124 stores a plurality of computer-readable instructions in the form of applications, including in the illustrated example a barcode detection application 128, whose execution by the processor 120 configures the device 100 to process images captured via the sensor 118 to detect and/or decode barcodes 112 therein.

The device 100 can also include a communications interface 132, enabling the device 100 to communicate with other computing devices (not shown) via any suitable communications links. The device 100 can also include one or more output devices, such as a display 142 (e.g., disposed on an opposite side of the device 100 from the sensor 118), a speaker (not shown), or the like. In other examples, the display 142 can be omitted, e.g., in the case of a barcode scanner with a ring form factor, implementations where the device 100 is a component of an autonomously-navigating apparatus, or the like. The device 100 can further include one or more input devices, such as a microphone, a touch screen (e.g., integrated with the display 142), a keypad, a scan trigger, or the like.

The device 100 implements, for example via the application 128, a detector 136 configured to process images captured via the sensor 118 to detect regions of interest therein containing barcodes, and a decoder 140 configured to process the regions of interest from the detector 136 to decode the barcodes contained in the regions of interest. The device 100 also implements an imaging controller, also referred to as an image signal processor (ISP) 144. The ISP 144 is shown as being implemented via the application 128, but in some embodiments can be implemented as a dedicated hardware controller integrated with the image sensor 118, the processor 120, or the like. The detector 136 and the decoder 140 can also be implemented via dedicated hardware rather than by the application 128 in other examples, such as a scan engine. The ISP 144 is configured to control components of the image sensor 118 to capture images for further processing (e.g., by the detector 136 and the decoder 140).

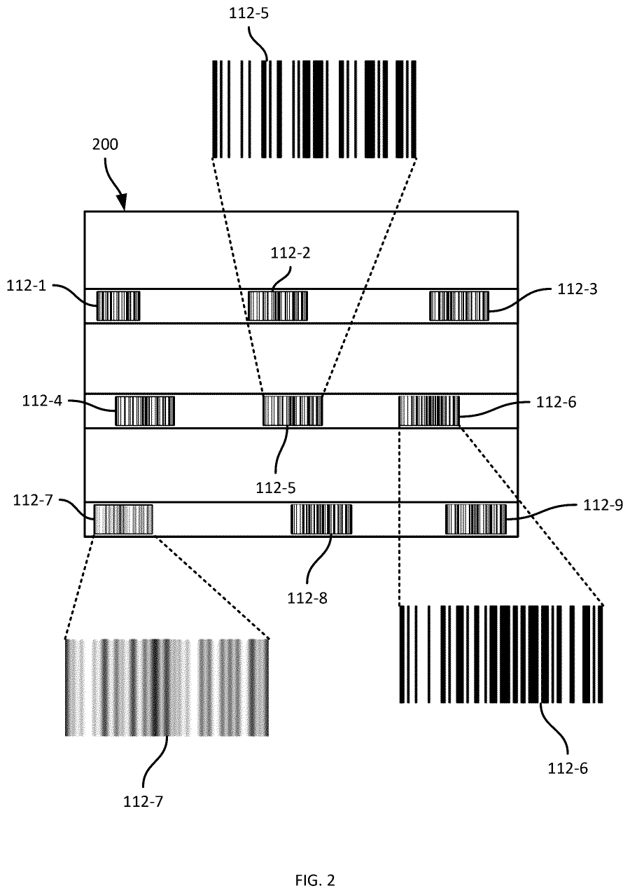

When the device 100 is operated to capture an image encompassing multiple barcodes 112, the device 100 (e.g., via the detector 136 and the decoder 140) can be configured to detect and attempt to decode each barcode 112 in the image. Certain barcodes may fail to decode, however. For example, referring to FIG. 2, an example image 200 captured by the sensor 118 and depicting the region 104 of the support structure 108 is illustrated. The image 200 contains the barcodes 112 mentioned in connection with FIG. 1, referred to individually in FIG. 2 as barcodes 112-1, 112-2, 112-3, 112-4, 112-5, 112-6, 112-7, 112-8, and 112-9 (collectively, the barcodes 112, and generically, a barcode 112; similar nomenclature may be used herein for other components whose reference numbers include hyphenated suffixes).

Certain barcodes 112 in the image 200 may be difficult to decode, e.g., as a result of being out of focus, as shown in connection with the area containing the barcode 112-7. The barcode 112-7 may therefore appear blurry in the image 200, and decoding the barcode 112-7 may fail, while the barcodes 112-5 and 112-7 are in focus and may therefore be successfully decoded. In other examples, specular lighting artifacts, shadows, or other environmental factors may render certain barcodes difficult to decode from the image 200. In some examples, the size of the barcodes 112 may vary, and the device 100 may fail to decode certain barcodes due to the small size of the barcodes, and insufficient detail in the image 200.

When decoding fails for one or more of the barcodes 112 in the image 200, the device 100 may be controlled (e.g., by an operator of the device 100 or the like) to capture additional images, and repeat attempts to detect and decode the barcodes 112. However, such repeated capture and decode operations may involve physically moving the device 100 towards such barcodes 112, and/or adjusting settings of the image sensor 118, such as zoom or the like. When the initial image 200 contained a plurality of barcodes to be decoded (e.g., tens of barcodes), tracking which of the full set of barcodes 112 has been successfully decoded may be challenging. The device 100 may therefore be manipulated to capture additional images of barcodes that have already been successfully decoded. The capture and processing of such images is an inefficient deployment of computational resources at the device 100.

An example approach to track which of the barcodes 112 has been successfully decoded is to present a list of decodes, e.g., on the display 142. The barcodes 112 may sometimes encode the same data, however (e.g., several barcodes 112 may encode the same product identifier), and it may therefore be difficult to determine from such a list which barcodes have or have not been decoded. Another example approach is to use motion tracking or the like, e.g., based on an inertial measurement unit (IMU) of the device 100, to determine positions of the device 100 itself and of the barcodes 112 in three dimensions. The device 100 can then track its own pose in space, and render indicators on the display 142 in association with the barcodes 112. That approach is, however, computationally demanding, and pose tracking is subject to drift such that the above-mentioned indicators may be presented in association with the wrong barcodes 112. Further, an approach such as that mentioned above does not provide guidance with respect to barcodes 112 that are not within a current FOV of the image sensor 118 (and therefore shown on the display 142). The lack of guidance with respect to those barcodes may lead to redundant captures of barcodes 112 that have already been decoded.

The device 100, as described below, implements functionality to provide guidance for additional image capture operations during batch decoding operations, e.g., of the image 200 or other images containing multiple barcodes 112. As described below, the device 100 tracks the positions of the barcodes 112 in an initial reference image. During subsequent image capture operations, e.g., to capture barcodes 112 that failed to decode in the initial attempt, the device 100 aligns subsequent images with the reference image to match barcodes 112 in the subsequent images with barcodes 112 in the reference image. The device 100 presents, during subsequent image capture operations, a current FOV of the image sensor 118, and a reference pane including decode status indicators for each barcode 112 in the initial image, providing positional guidance to the operator of the device 100 and thus reducing the likelihood of redundant barcode captures.

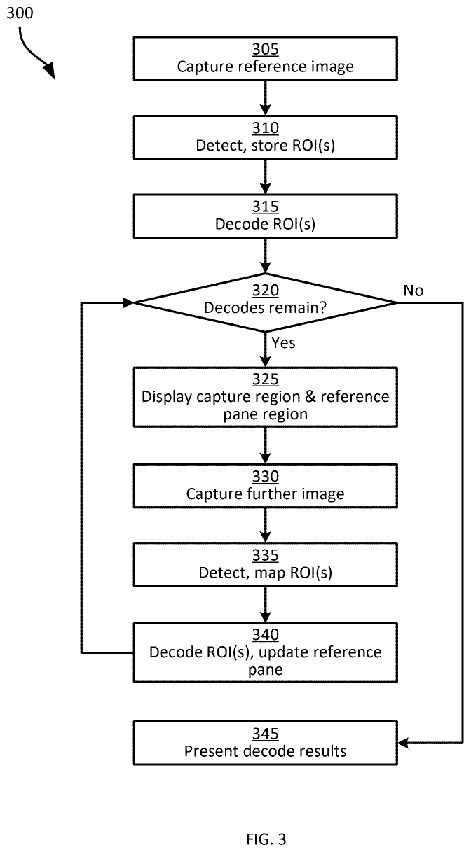

Turning to FIG. 3, a method 300 of batch barcode scanning is illustrated. The method 300 is described below in conjunction with its performance at the device 100, e.g., via execution of the application 128 by the processor 120, and/or by equivalent dedicated hardware elements as noted earlier.

At block 305, the device 100 is configured to capture a reference image (e.g., the image 200 shown in FIG. 2). For example, the processor 120 can transmit a capture command to the sensor 118. The capture command can include a command to capture a single image frame, or to initiate capture of a sequence of image frames, e.g., in a continuous or video capture mode, at a suitable frame rate (e.g., 10 frames per second, although both slower and faster capture rates may be employed, depending on the capabilities of the sensor 118 and the computational resources available to process the captured images).

The image captured at block 305 can have a first resolution, which may also be referred to as a “high” resolution, relative to subsequent images captured by the device 100. For example, the image captured at block 305 can have a resolution of about 15 MP, whereas subsequent images captured during performance of the method 300 can have resolutions of about 2 MP. As will be apparent, a wide variety of other image resolutions can also be employed, depending on the capabilities of the image sensor 118 and the computational resources of the device 100 (as processing higher-resolution images involves greater computational load). In some examples, the images captured throughout the method 300 can have the same resolution.

In some examples, at block 305 the device 100 captures two images substantially simultaneously. A first image can include a high-resolution image, e.g., the image 200 as discussed above. A second image, which can be used as a reference image in the remainder of the method 300, can include a lower-resolution image with a substantially equivalent field of view. For example, the device 100 can capture a high-resolution image, and generate the reference image by scaling the high-resolution image.

At block 310, the device 100 is configured to detect one or more regions of interest (ROI) in the image from block 305. For example, the detector 136 can be configured to detect areas in the image with vertical gradients indicating the presence of a barcode. As will be apparent to those skilled in the art, various other mechanisms can be employed to detect the positions of barcodes in the image 200. In some examples, the detector 136 can implement a machine-learning based classifier, trained to detect barcodes of various symbologies and return the positions of likely barcodes (e.g., regardless of symbology). The detector 136 produces, at block 310, one or more positions such as bounding boxes defined in image coordinates (e.g., coordinates corresponding to the sensor 118, or that can be mapped to sensor coordinates via calibration data of the sensor 118).

The device 100 is configured to maintain the positions of the ROIs for later use, e.g., in the memory 124. The device 100 can also be configured to determine and store one or more feature descriptors associated with the reference image from block 305. For example, the device 100 can identify feature points in the reference image that are likely to be robust locations for matching the reference image with other images encompassing at least some of the region 104. A wide variety of approaches for generating feature descriptors will occur to those skilled in the art. For example, the device 100 can be configure to implement the scale-invariant feature transform (SIFT) algorithm to identify points in the reference image that are likely to be robust matching candidates at different image sizes, light levels, rotation, and the like. Each selected point can be represented by a feature descriptor, e.g., a numerical vector indicating a position of the point and one or more attributes of the point.

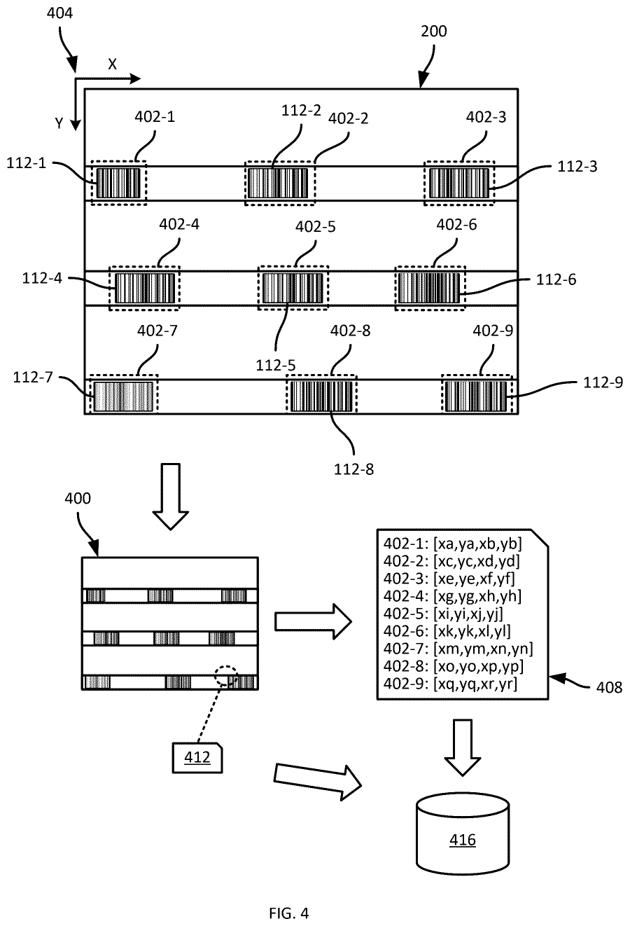

FIG. 4 illustrates an example performance of blocks 305 and 310. In particular, at block 305 the device 100 captures the image 200, as discussed in connection with FIG. 2. The device 100 also, in this example, generates a reference image 400, e.g., having a lower resolution than the image 200. In other examples, the image 200 can be used as the reference image. The device 100 is configured, at block 310, to detect a set of ROIs 402-1, 402-2, 402-3, 402-4, 402-5, 402-6, 402-7, 402-8, and 402-9 corresponding to the barcodes 112. The device 100 can detect the ROIs 402 from the image 200, when the reference image is generated separately from the image 200. Each ROI 402, in this example, is a rectangular bounding box which may be defined by pixel coordinates (e.g., according to a coordinate system 404) of each corner, coordinates of the upper-left corner and lower-right corner, or the like. The device 100 can be configured to store the ROIs 402, e.g., in a list 408 or other data structure in the memory 124, with each ROI 402 being defined in the list 408 by an identifier (e.g., “402-1”) and a set of coordinates. The ROIs 402, in this example, are converted to coordinates corresponding to the reference image 400 (e.g., the ROIs 402 are scaled down to align with the reference image 400) prior to storage.

The device 100 can also extract a plurality of feature descriptors 412 from the reference image 400. The list 408 of ROIs 402, and the feature descriptors 412, can be stored in a repository 416 or other suitable location(s) in the memory 124.

Returning to FIG. 3, at block 315 the device 100 is configured to initiate a decode operation for each barcode 112 in the image 200. For example, each ROI 402 can be extracted from the image 200 and passed to the decoder 140. Each decode operation may or may not succeed. The outcome of each decode operation, in other words, can be decoded data if the decode operation succeeded, or an error or failure indicator if the decode operation failed. The decode results can also include other information, such as the symbology of the barcode 112 in the corresponding ROI 402. The results of any successful decode operations at block 315 are stored, e.g., in association with the positions of the corresponding ROIs 402.

At block 320, the device 100 is configured to determine whether any barcodes 112 from the initial image captured at block 305 remain to be decoded. In other words, the device 100 is configured to determine whether any of the decode operations initiated at block 315 failed. When the determination at block 320 is negative, indicating that all the barcodes 112 have been successfully decoded, performance of the method 300 can end with the output of the decode results, as described further below.

When the determination at block 320 is affirmative, because at least one barcode 112 was not successfully decoded at block 315, the device 100 proceeds to block 325. Beginning at block 325, the device 100 is configured to permit the capture of additional images to decode barcodes 112 that were not successfully decoded at block 315. Also beginning at block 325, in response to such addition image captures, the device 100 is configured to provide an up-to-date (e.g., substantially in real time) visual representation of the decode status of each barcode 112 from the reference image 400 captured at block 305.

At block 325, the device 100 is configured to enable the image sensor 118, e.g., to capture a sequence of images and render the images on the display 142. The images need not be stored persistently in the memory 124, but can instead be presented as an electronic viewfinder or “preview” image capture function. The device 100 can present the field of view of the image sensor 118 in a first region of the display 142, updating that region of the display in response to each new frame captured in the sequence.

The device 100 is also configured, at block 325, to display a reference pane in a second region of the display 142. The reference pane includes positions of each ROI 402 (that is, each barcode 112) from the reference image 400. The positions can be shown overlaid on the reference image 400 itself, or as bounding boxes or other suitable graphical elements positioned relative to one another in the same way as in the reference image 400. The reference pane also includes a decode status indicator in association with each barcode 112 in the reference image 400. The decode status indicators indicate whether each barcode 112 has been successfully decoded.

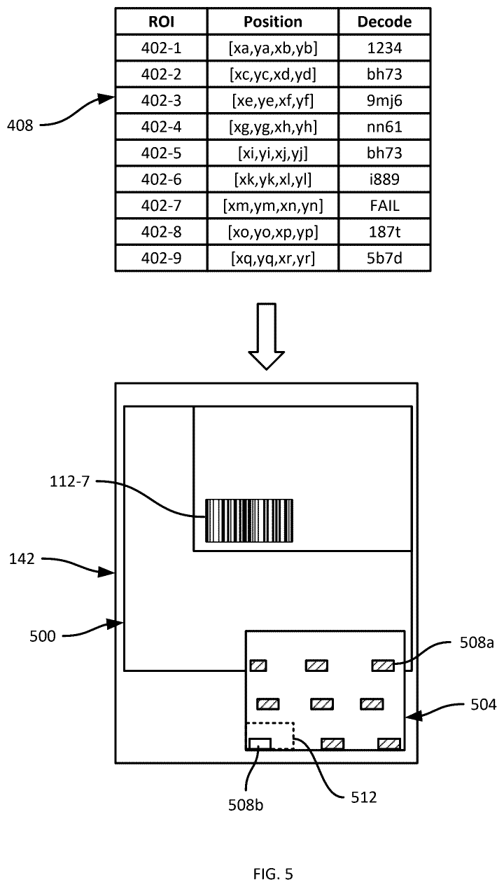

Turning to FIG. 5, an example of the list 408 introduced in FIG. 4 is shown, updated to include decode result from block 315. As shown in FIG. 5, each ROI 402 except the ROI 402-7 (which contains the barcode 112-7) has been successfully decoded. The record associated with the ROI 402-7 contains a failure indicator. In other examples, the decode data associated with the ROI 402-7 can be empty until a successful decode operation.

FIG. 5 also illustrates a first region 500, and a second region 504 presented on the display 142. The first region 500 depicts a current FOV of the image sensor 118. As shown in FIG. 5, the current FOV of the image sensor 118 contains the barcode 112-7, e.g., because the device 100 has been moved to approach the barcode 112-7 and/or the image sensor 118 has been controlled to zoom in on the barcode 112-7 from the position of the device 100 shown in FIG. 1. The first region 500 can be updated substantially in real-time to provide an electronic viewfinder function, as noted above.

The second region 504 includes the position of each ROI 402 within the reference image 400. The second region 504 can include a reference pane, configured to provide positional guidance for use in positioning the device 100 to capture any barcodes 112 that have not yet been decoded. The reference pane can include the reference image 400, or as illustrated in FIG. 5, can include indications of the ROIs 402 relative to the boundaries of the reference image 400, without including the reference image 400 itself. The second region 504 also includes a decode status indicator corresponding to each barcode 112. The decode status indicators, in this example, are selected from a first indicator 508a indicating successful decoding, and a second indicator 508b indicating failed decoding.

The indicators 508a and 508b can include overlay elements, e.g., with different colors, patterns, borders or the like. In some examples, the decode status indicators can include an overlay for successful decodes, and no overlay for failed decodes. In other examples, the decode status indicators can include an overlay for failed decodes, and no overlay for successful decodes. As will be apparent, the reference pane in the second region 504 can aid an operator of the device 100 in selecting where to position the FOV 116 of the image sensor 118 to capture any barcodes not previously decoded. In some examples, as shown in FIG. 5, the reference pane can include a boundary 512 indicating the position of the current FOV 116 relative to the reference image. The boundary 512 can be determined by, for each preview frame captured by the image sensor 118, extracting a plurality of feature descriptors and matching those feature descriptors to the descriptors 412 previously stored in connection with the reference image 400. Using the descriptors 412 and the descriptors extracted from the current FOV 116, the device 100 can determine a transform (e.g., a matrix defining one or more of translation, rotation, and scaling relative to the reference image 400) between the reference image 400 and the current FOV 116.

Returning to FIG. 3, at block 330, the device 100 is configured to capture a further image, e.g., in response to a capture command from an input such as a touch screen integrated with the display 142, a button, or the like. For example, the device 100 can capture an image corresponding to the current FOV 116 shown in the region 500 in FIG. 5. At block 335, the device 100 is configured to detect one or more ROIs 402 as described in connection with block 310. Rather than storing the ROI(s) from block 335 as new ROIs, however, the device 100 is configured to match the ROI(s) from block 335 to the ROIs 402 of the reference image 400.

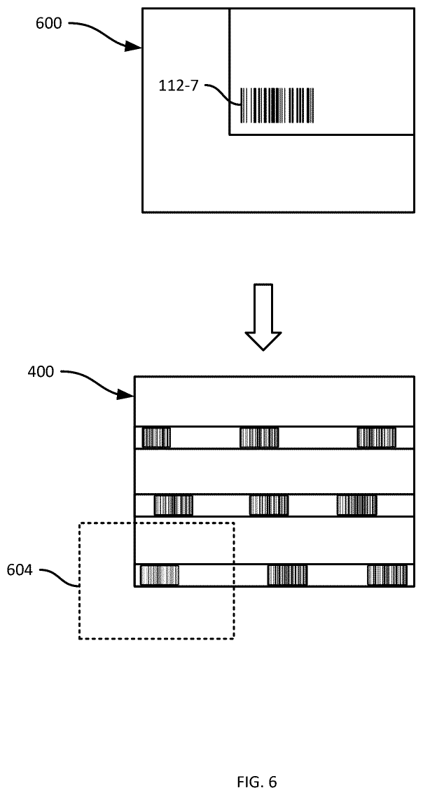

Turning to FIG. 6, an image 600 is shown as captured at block 330, containing the barcode 112-7. The image 600 has the same resolution as the reference image 400, in this example. The device 100 is configured to extract a plurality of feature descriptors from the image 600, and by comparing those feature descriptors to the descriptors 412 stored in association with the reference image 400, align the images 400 and 600 with each other. As shown in FIG. 6, the device 100 can determine a position 604 of the image 600 relative to the reference image 400, based on such feature mapping. The device 100 can be configured to transform the coordinates (e.g., a bounding box or the like) of the barcode 112-7 in the image 600 into the coordinate system 404 of the reference image 400, and match the barcode 112-7 in the image 600 with the ROI 402-7 in the reference image 400. In some examples, the barcodes 112 in the reference image 400 may be sufficiently close that an imperfect mapping of the image 600 to the reference image 400 may lead to the barcode 112-7 overlapping more than one ROI 402. In such examples, the device 100 can compute a matching metric, such as an Intersection over Union (IoU) metric for each overlapping ROI 402, and match the barcode 112-7 with the ROI 402 having the highest metric.

Referring again to FIG. 3, at block 340, the device 100 is configured to decode the ROI detected in the image 600, and update the reference pane in the region 504 based on the outcome of the decode operation. That is, the device 100 is configured to attempt to decode the barcode 112-7 from the image 600. When the decode operation is successful, the device 100 is configured to update the region 504 to replace the status indicator 508b with an indicator 508a. When the decode operation fails, the device 100 can be configured to leave the region 504 unchanged. The device 100 returns to block 320 after updating the region 504 (or leaving the region 504 unchanged, in the event of a failed decode operation).

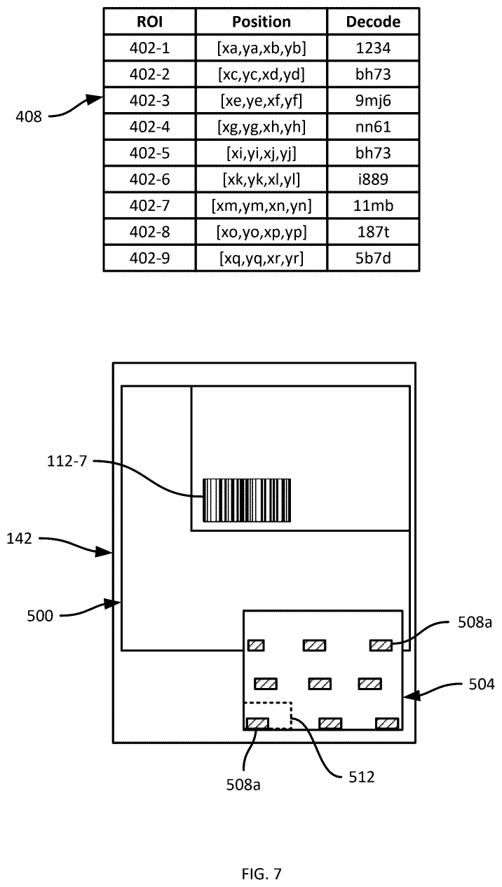

FIG. 7 illustrates the results of a performance of blocks 330 to 340, in which the barcode 112-7 is successfully decoded from the image 600. The reference pane in the region 504 uses decode status indicators 508a for each barcode 112, and the list 408 is updated to include a decoded value for the barcode 112-7.

In this example, the next determination at block 320 is therefore negative. The device 100 therefore proceeds to block 345, to present decode results for the batch of barcodes 112 in the reference image 400. Presenting the decode results can include listing each decoded value on the display 142, sending the decoded values to another computing device, or the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing a sequence of images including a first image and a plurality of further images;
detecting a plurality of barcodes in the first image;
for each of the plurality of further images:
detecting at least one of the plurality of barcodes;
initiating a decode operation for the at least one barcode;
determining a position of the at least one barcode within the first image; and
controlling a display to indicate a result of the decode operation at the position.

2. The method of claim 1, further comprising:
selecting, in the first image, a plurality of feature points;
determining the position of the at least one barcode within the first image by detecting matching feature points in the further image.

3. A method, comprising:
capturing a first image;
detecting a plurality of barcodes in the first image;
initiating a decode operation for each of the barcodes;
controlling a display to present:
in a first region of the display, a field of view of an image sensor, and
in a second region of the display, a reference pane including (i) positions of each of the barcodes in the first image, and (ii) a decode status indicator associated with a first barcode of the plurality of barcodes, the decode status indicator corresponding to an outcome of the decode operation for the first barcode; and
updating the reference pane based on at least one further decode operation.

4. The method of claim 3, wherein the reference pane is overlaid on a portion of the field of view of the image sensor.

5. The method of claim 3, wherein the decode status indicator is at the position of the first barcode within the first image.

6. The method of claim 3, wherein the decode status indicator is selected from a first indicator corresponding to a successful decode operation, and a second indicator corresponding to a failed decode operation.

7. The method of claim 3, further comprising, prior to controlling the display, determining that at least one of the decode operations failed.

8. The method of claim 3, wherein updating the reference pane comprises:
capturing a second image corresponding to the field of view of the image sensor;
detecting a barcode in the second image;
matching the barcode detected in the second image with a second one of the barcodes in the first image;
decoding the barcode detected in the second image; and
controlling the display to update a decode status indicator associated with the second barcode in the reference pane.

9. The method of claim 8, wherein matching the barcode detected in the second image with the second barcode includes:
determining a transform to align the second image with the first image.

10. The method of claim 9, further comprising:
mapping a position of the barcode in the second image to a position in the first image using the transform; and
determining that the position in the first image overlaps with the second barcode.

11. The method of claim 8, further comprising:
capturing the second image in response to receiving a capture command.

12. The method of claim 3, wherein the second region of the display is smaller than the first region of the display.

13. A computing device, comprising:
an image sensor;
a display; and
a processor configured to:
capture a first image;
detect a plurality of barcodes in the first image;
initiate a decode operation for each of the barcodes;
control the display to present:
in a first region of the display, a field of view of an image sensor, and
in a second region of the display, a reference pane including (i) positions of each of the barcodes in the first image, and (ii) a decode status indicator associated with a first barcode of the plurality of barcodes, the decode status indicator corresponding to an outcome of the decode operation for the first barcode; and
update the reference pane based on at least one further decode operation.

14. The computing device of claim 13, wherein the reference pane is overlaid on a portion of the field of view of the image sensor.

15. The computing device of claim 13, wherein the decode status indicator includes an overlay on the one of the barcodes.

16. The computing device of claim 13, wherein the decode status indicator is selected from a first indicator corresponding to a successful decode operation, and a second indicator corresponding to a failed decode operation.

17. The computing device of claim 13, wherein the processor is configured, prior to controlling the display, to determine that at least one of the decode operations failed.

18. The computing device of claim 13, wherein the processor is configured to update the reference pane by:
capturing a second image corresponding to the field of view of the image sensor;
detecting a barcode in the second image;
matching the barcode detected in the second image with a second one of the barcodes in the first image;
decoding the barcode detected in the second image; and
controlling the display to update a decode status indicator associated with the second barcode in the reference pane.

19. The computing device of claim 18, wherein the processor is configured to match the barcode detected in the second image with the second barcode by:
determining a transform to align the second image with the first image.

20. The computing device of claim 19, wherein the processor is configured to:
map a position of the barcode in the second image to a position in the first image using the transform; and
determine that the position in the first image overlaps with the second barcode.

21. The computing device of claim 18, wherein the processor is configured to:
capture the second image in response to receiving a capture command.

22. The computing device of claim 13, wherein the second region of the display is smaller than the first region of the display.
